(19) United States
(12) Patent Application Publication
(10) Pub. No.: US 2017/0357377 A1
(43) Pub. Date: Dec. 14, 2017

(54) Touch Control Module and Tracking Method For Touch Point and Touch Sensitive Electronic Device Using Same

(71) Applicants: IMAGINATION BROADWAY LTD., New Taipei City (TW); SALT International Corp., New Taipei City (TW)

(72) Inventors: Shang-Li Lee, New Taipei City (TW); Hong-Lun Su, New Taipei City (TW)

(21) Appl. No.: 15/622,229

(22) Filed: Jun. 14, 2017

(30) Foreign Application Priority Data
Jun. 14, 2016 (TW) 105118548

(51) Int. Cl. G06F 3/041

(52) U.S. Cl. CPC G06F 3/0418; G06F 2203/04104

(57) ABSTRACT

A touch control module and a tracking method for touch point and a touch sensitive electronic device are provided. The device includes a multi-touch touch panel and the touch control module. The module performs the tracking method including the following steps. N first touch points and M candidate points are acquired respectively in a first and a second detecting period. When any one of the candidate points falls within a pairing extent of any one of the first touch point, the control module pairs the candidate point with the first touch point. The detecting perimeter is a function of a minimum detecting value and a distance-between-finger value. K paired candidate points are assigned as K second touch points. A maximum interval distance among the K pairs is retrieved, and the pairing extent can be adjusted according to the maximum interval distance.

### RELATED APPLICATIONS

This application claims priority to Taiwan patent application, No. 105118548, filed on Jun. 14, 2016, entitled “Touch Control Module and Tracking Method for Touch Point and Touch Sensitive Electronic Device Using Same”, which is hereby incorporated by reference in its entirely.

### BACKGROUND OF THE INVENTION

### Technical Field

The present invention relates to a touch control module and tracking method for touch point and touch sensitive electronic device. More particularly, the present invention relates to a multi-point touch control module and tracking method for multiple touch points and touch sensitive electronic device using the same.

### Description of Related Art

As touch sensitive technology develops, traditional single touch point detection is no longer sufficient and unable to match the criteria for fluent and intuitive gesture inputs. As a result, the market is turning its attention to the technical field relating to multi-touch and pouring more and more resources into the development of multi-touch technology.

In one known touch panel, the locations of touch points can be acquired by a full panel scan. In the full panel scan process, the whole touch detection area of the touch panel is scanned to detect the locations of the touch points. With the increment in the number of touch points and the resolution of the touch sensor array, the touch panel must face the challenges accompanying with higher detection density. For example, with higher detection density, the touch controller of the touch panel may not be able to complete the scan in an effective period of time, and the problems like belated reporting the touch points and even failure of reporting one or more touch points arise. In addition, the touch panel would be easily subject to noises during the detection process, and may ultimately result in signal jittering or error reporting of the touch points.

These problems are more significant on a touch panel that reports multiple touch points at the same time. After two or more detection cycles, a faulty touch point tracking may occur easily. The touch trails of tracking the touch points may be twisted in large angles or may be overlapped with each other, and even the number of the touch trails may be wrongly calculated. Under these circumstances, the accuracy and the correctness of touch point reporting by the touch panel would be affected, and thus user operation would be interfered as well, and the overall product quality is affected. Therefore, there exists a need for an improved tracking method for touch points to eliminate the above-mentioned drawbacks.

### SUMMARY

The touch control module and tracking method for touch point and touch sensitive electronic device using same of the present invention uses a pairing extent, which is a function of a minimum detecting value and a distance-between-finger value, to determine whether the touch points are on the same trail or not. The faulty touch point tracking can be prevented, and the tracking accuracy and correctness can be improved by adjusting the pairing extent during the tracking process.

According to one aspect of the invention, a tracking method for touch points is provided. The tracking method includes the following steps. First, N first touch points are acquired in a first detecting cycle, and M candidate points are acquired in a second detecting cycle after the first detecting cycle. N and M are positive integers. When any one of the M candidate points situates within a pairing extent of any one of the N first touch points, the candidate point is paired with the first touch point. The pairing extent is a function of a minimum detecting value and a distance-between-finger value. Each pair of the candidate point and the first touch point has an interval distance therebetween. After K pairs of the candidate point and the first touch point are paired, K paired candidate points are assigned as K second touch points. Each second touch point and corresponding first touch point are defined as being on the same trail. Then, a maximum interval distance is retrieved from the K pairs of the candidate point and the first touch point. After that, the pairing extent is adjusted in accordance with the maximum interval distance.

In one embodiment of the tracking method, the pairing extent is in a circular shape whose radius is the sum of the distance-between-finger value and a half of the minimum detecting value.

In one embodiment of the tracking method, the tracking method further includes a designating step. One or more remaining unpaired candidate points are designated as one or more new touch points. The designating step includes a setting step. When a location difference between one remaining unpaired candidate point and one nearest first touch point is larger than a threshold, the remaining unpaired candidate point is set as one of the new touch points.

In one embodiment of the tracking method, the tracking method further includes the following steps. One or more remaining unpaired candidate points are designated as one or more new touch points. L first touch points are acquired by aggregating the K second touch points and the new touch points. The tracking method is resumed from the step of acquiring M candidate points.

In one embodiment of the tracking method, the step of adjusting to the pairing extent includes the following steps. An evaluating value is obtained according to the minimum detecting value and the distance-between-finger value. The distance-between-finger value is updated with double its original value when the maximum interval distance is greater than a half of the evaluating value, thereby expanding the pairing extent. The evaluating value is a half of the sum of the minimum detecting value and the distance-between-finger value.

In one embodiment of the tracking method, the step of adjusting the pairing extent includes the following steps. An evaluating value is obtained according to the minimum detecting value and the distance-between-finger value. The distance-between-finger value is updated with half its original value when the maximum interval distance is smaller than a quarter of the evaluating value, thereby contracting the pairing extent. The evaluating value is a half of the sum of the minimum detecting value and the distance-between-finger value.

According to another aspect of the invention, a touch control module is provided. The touch control module is electrically connected to a multitouch panel for receiving several touch signals from the multitouch panel, thereby identifying and tracking several touch points on the multitouch panel. The touch control module is configured to perform a tracking method comprising the following steps. N first touch points are acquired in a first detecting cycle, and M candidate points are acquired in a second detecting cycle after the first detecting cycle. N and M are positive integers. When any one of the M candidate points situates within a pairing extent of any one of the N first touch points, the candidate point is paired with the first touch point. The pairing extent is a function of a minimum detecting value and a distance-between-finger value, and each pair of the candidate point and the first touch point has an interval distance therebetween. After K pairs of the candidate point and the first touch point are paired, K paired candidate points are assigned as K second touch points. Each second touch point and corresponding first touch point are defined as being on the same trail. A maximum interval distance is retrieved from the K pairs of the candidate point and the first touch point, and then the pairing extent Is adjusted in accordance with the maximum interval distance.

According to yet another aspect of the invention, a touch sensitive electronic device is provided. The touch sensitive electronic device includes a multitouch panel and a touch control module. The multitouch panel is used for generating several touch signals. The touch control module is connected to the multitouch panel for receiving the touch signals, thereby identifying and tracking several touch points on the multitouch panel. The touch control model is configured to acquire N first touch point in a first detecting cycle and M candidate points in a second detecting cycle after the first detecting cycle. When any one of the M candidate points situates within a pairing extent of any one of the N first touch points where the pairing extent is a function of a minimum detecting value and a distance-between-finger value, the touch control module is configured to pair the candidate point with the first touch point. The touch control module is configured to assign K paired candidate points as K second touch points, and each second touch point and corresponding first touch point are defined as being on the same trail. The touch control module is further configured to retrieve a maximum interval distance from more than one pair of the candidate point and the first touch point and to adjust the pairing extent in accordance with the maximum interval distance.

According to the disclosure of the touch control module and tracking method for touch points and touch sensitive electronic device, the pairing extent is used for determining whether the touch points are on the same trail or not. The problems like faulty touch point tracking caused by noises or increasing finger numbers can be prevented. The correctness of touch point tracking can be improved, and the accuracy of tracking can be increased by accordingly adjusting the pairing extent. The touch sensitive electronic device can be operated with better precision, and therefore provide better user experience and product quality.

### BRIEF DESCRIPTION OF DRAWINGS

The invention can be more fully understood by reading the following detailed description of the embodiment, with reference made to the accompanying drawings as follows:

FIG. 1 is a flow chart of a tracking method according to one embodiment of the invention;

FIG. 2a is a schematic view of the first touch points according to one embodiment of the invention;

FIG. 2b is a schematic view of the first touch points and the candidate points; FIG. 2c is a schematic view of one first touch point of FIG. 2b and its pairing extent;

FIG. 2d is a schematic view of the pairing status of the first touch points and the candidate points of FIG. 2b;

FIG. 3 is a flow chart of sub-steps of step S50 of FIG. 1;

FIG. 4 is a schematic view of the location differences between the remaining unpaired candidate points and respective nearest first touch points;

FIG. 5 is a schematic view of the new first touch points; and

FIG. 6 is a schematic view of a touch sensitive electronic device according to another embodiment of the invention.

### DETAILED DESCRIPTION

The touch control module and tracking method for touch points and touch sensitive electronic device of the present invention use a pairing extent to determine whether a first touch point and a neighboring candidate point are on the same touch trail or not. The pairing extent is a function of a minimum detecting value and a distance-between-finger value. The problem of faulty touch point tracking may be prevented therefrom. The accuracy of touch point tracking can be increased by way of a feedback-and-adjustment mechanism. Reference will now be made in detail to elaborate the contents and the features of the embodiments of the present invention, examples of which are illustrated in the accompanying drawings.

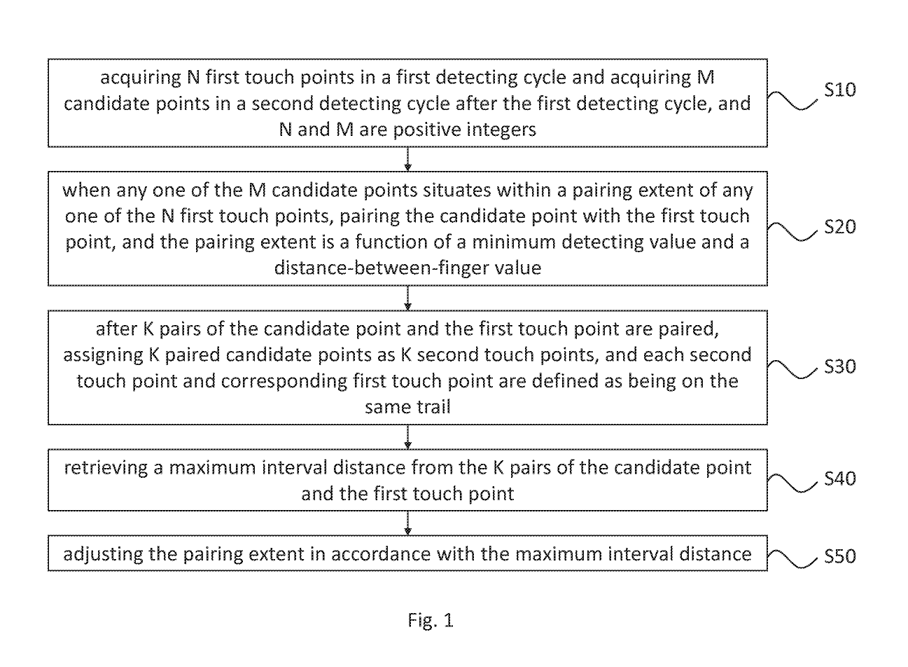

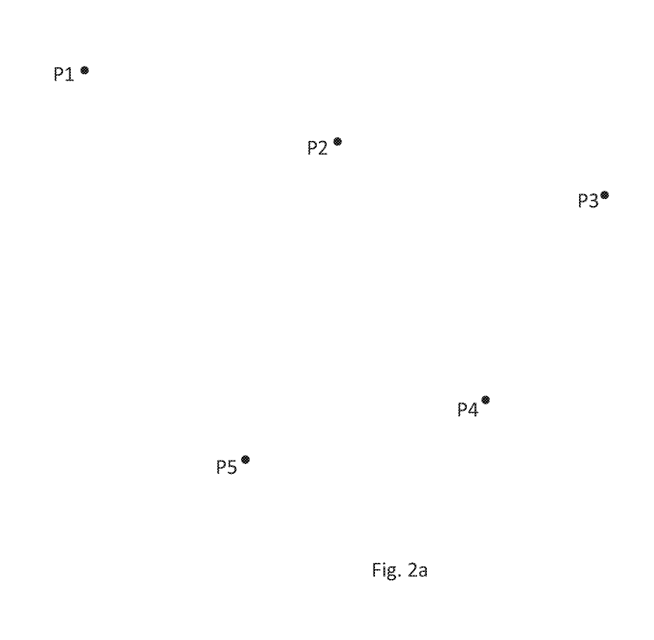

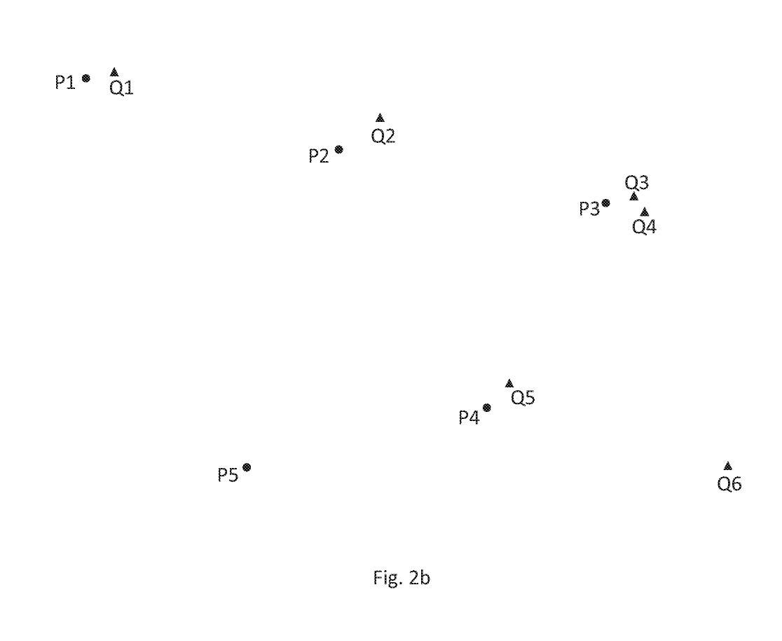

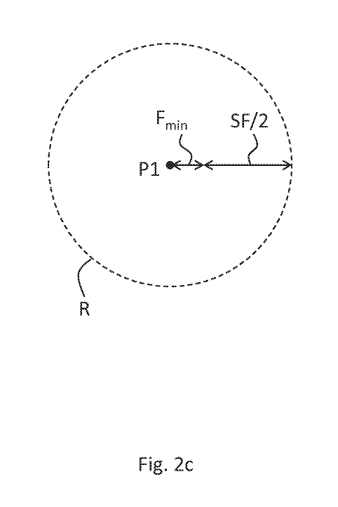

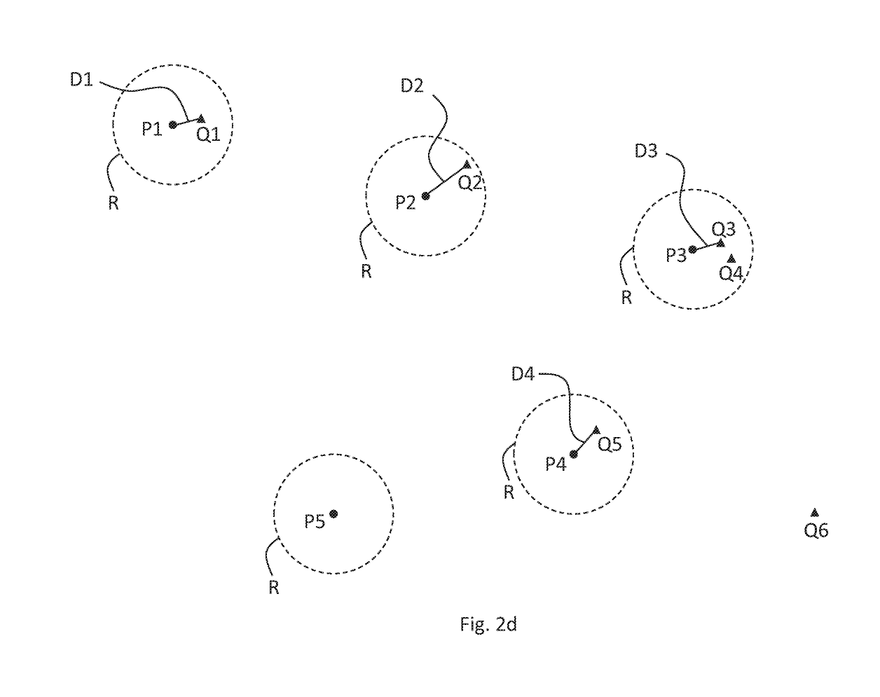

Please refer to FIG. 1 which is a flowchart of a tracking method according to one embodiment of the invention. First, the tracking method of the present embodiment performs step S10. In step S10, N first touch points are acquired in a first detecting cycle and M candidate points are acquired in a second detecting cycle after the first detecting cycle. N and M are positive integers. Please refer to FIG. 2a and FIG. 2b at the same time. FIG. 2a is a schematic view of the first touch points according to one embodiment of the invention. FIG. 2b is a schematic view of the first touch points and the candidate points. In the present embodiment, five first touch points P1˜P5 are acquired in the first detecting cycle as shown in FIG. 2a, and thus N equals five herein. In the following second detecting cycle, six candidate points Q1˜Q6 are acquired as shown in FIG. 2b, and thus M equals six herein.

Practically, the tracking method may include one or more steps before step S10. For example, a step of determining whether one or more initial points are detected or not can be performed before step S10. When a multitouch panel initially begins to perform touch point detection (e.g. the device is just booted, hardware is just powered-on, or firmware/software is still loading), or when none of the touch points can be detected in the previous detecting cycle, the touch control module of the multitouch panel does not get any touch point. It is thus determined that none of the initial points is detected, and the number of the initial point is zero.

When it is determined that none of the initial points is detected, a full panel scan of the touch panel is performed. The full panel scan is repeated until one or more touch points are detected. The detected touch points are then regarded as N first touch points, and the detecting cycle that acquires the touch points is regarded as the first detecting cycle.

After step S10 is finished, N first touch points P1-P5 and M candidate points Q1˜Q6 are acquired, as shown in FIG. 1. The tracking method then moves on to step S20. In step S20, when any one of the M candidate points situates within a pairing extent of any one of the N first touch points, the candidate point is paired with the first touch point. Please refer to FIG. 2c which is a schematic view of one first touch point of FIG. 2b and its pairing extent. The pairing extent R is a function of a minimum detecting value Fₘᵢₙ and a distance-between-finger value SF.

The minimum detecting value Fₘᵢₙ and the distance-between-finger value SF are numerical values that can be set or acquired in advance. The minimum detecting value Fₘᵢₙ indicates the smallest area of a touch point that the touch panel can recognize. In other words, the area of a touch point must be equal to or larger than the minimum detecting value Fₘᵢₙ so the touch point can be detected by the touch panel. The distance-between-finger value SF is the minimum distance between two touch points that the touch panel can recognize. The distance between two touch points must be equal to or larger than the distance-between-finger value SF so the two touch points can be distinguished by the touch panel. The minimum detecting value Fₘᵢₙ and the distance-between-finger value SF can be determined in accordance with the highest detection resolution of hardware, yet they can also be determined based on actual product needs.

In one embodiment, the pairing extent R is in a circular shape and its radius is the sum of the distance-between-finger value SF and a half of the minimum detecting value Fₘᵢₙ. In other words, the pairing extent R is a circle area whose center is its corresponding first touch point P1˜P5 and whose radius is (Fₘᵢₙ+½*SF). When one candidate point Q1-Q6 situates within the pairing extent R of one first touch point P1˜P5, the candidate point Q1˜Q6 is paired with the first touch point P1˜P5. In the case of more than one candidate points Q1˜Q6 situating within the pairing extent R of one first touch point P1˜P5, the nearest candidate point Q1˜Q6 is selected to be paired therewith.

Please refer to FIG. 2d which is a schematic view of the pairing status of the first touch points and the candidate points of FIG. 2b. In the present embodiment, there are four pairs of the first touch point P1˜P5 and the candidate point Q1-Q6, namely (P1, Q1), (P2, Q2), (P3, Q3), and (P4, Q5). The two points in each pair are separated by a distance smaller than the pairing extent R. Among all the candidate points Q1˜Q6 in the present embodiment, four (Q1, Q2, Q3, and Q5) are paired and two (Q4 and Q6) are not.

As shown in FIG. 2d, none of the candidate points Q1-Q6 is provided within the pairing extent R of the first touch point P5, which is the bottom one among all the first touch points P1-P5. Therefore, this first touch point P5 is not paired with any candidate point Q1˜Q6. The candidate point Q4, which is the fourth one from the top, is not paired with any first touch point P1˜P5. Although the candidate point Q4 indeed situates within the pairing extent R of the first touch point P3, it is not the closer one (comparing to the candidate point Q3) to the first touch point P3. The candidate point Q6, which is the bottom one among all the candidate points Q1˜Q6, is not provided within any pairing extent R of any first touch point P1-P5, and thus is not paired with any first touch point P1-P5.

After step S20, the tracking method moves on to step S30, as shown in FIG. 1. In step S30, after K pairs of the candidate point and the first touch point are paired, the K paired candidate points are assigned as K second touch points. Each second touch point and its corresponding first touch point are defined as being on the same trail. In the present embodiment, the aforementioned four paired candidate points Q1, Q2, Q3, and Q5 are assigned as four second touch points. Each second touch point is defined as being on the same trail with its corresponding first touch point P1-P4, as indicated by the four solid lines in FIG. 2d. The four second touch points (former candidate points Q1, Q2, Q3, and Q5) are respectively the next points of the first touch points P1-P4. Here K equals four in the present embodiment.

Step S40 is performed after step S30. In step S40, a maximum interval distance from the K pairs of the candidate point and the first touch point is retrieved. Each pair of points has an interval distance, and the maximum interval distance is the greatest among the interval distances of the pairs. As the four pairs of points (P1, Q1), (P2, Q2), (P3, Q3), and (P4, Q5) shown in FIG. 2d, the first touch points P1-P4 and the corresponding candidate points Q1, Q2, Q3, and Q5 are separated by a first interval distance D1, a second interval distance D2, a third interval distance D3, and a fourth interval distance D4 respectively. In the present embodiment, the second interval distance D2 is the greatest one, so the second interval distance D2 is the maximum interval distance.

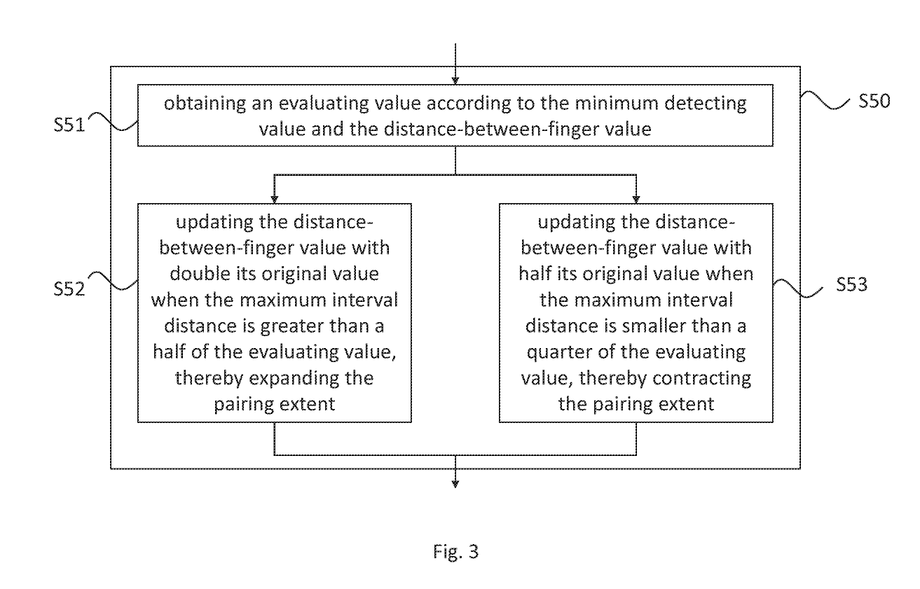

Please refer to FIG. 1, the tracking method continues to step S50. The pairing extent is adjusted in accordance with the maximum interval distance. Step S50 will be elaborated in more detail with reference to FIG. 3 which is a flowchart of sub-steps of step S50.

Step S50 of the present embodiment includes the following steps. First, in step S51, an evaluating value is obtained according to the minimum detecting value Fₘᵢₙ and the distance-between-finger value SF. To be more specific, the evaluating value is a half of the sum of minimum detecting value Fₘᵢₙ and the distance-between-finger value SF; that is, evaluating value equals to (½*(Fₘᵢₙ+SF)). Afterward, the evaluating value is compared with the retrieved maximum interval distance (the second interval distance D2 herein). The tracking method will be directed to different sub-steps according to the comparison result.

According to one aspect of the comparison result, when the maximum interval distance is greater than a half of the evaluating value, the tracking method is directed to step S52. The distance-between-finger value SF is updated with double its original value, thereby expanding the pairing extent R. In one example, the maximum interval distance (the second interval distance D2 herein) is assumed to be greater than a half of the evaluating value. From the pairing status exemplified in FIG. 2d, it means that the location difference between the candidate point Q2 and the first touch point P2 is so great that it may indicate the finger is moving faster. Therefore, the distance-between-finger value SF is updated with double its original value in an attempt to pair touch points with wider pairing extent R in the next detecting cycle (e.g. a third detecting cycle). With wider pairing extent R, the likelihood of being unable to find the touch point is decreased.

According to another aspect of the comparison result, when the maximum interval distance is smaller than a quarter of the evaluating value, the tracking method is directed to step S53. In step 53, the distance-between-finger value SF is updated with half its original value, thereby contracting the pairing extent R. In another example, the maximum interval distance (the second interval distance D2 herein) is assumed to be smaller than a quarter of the evaluating value. It may indicate that the finger is moving to slower. Therefore, the distance-between-finger value SF is updated with half its original value in an attempt to pair touch points with narrower pairing extent R in the next detecting cycle (e.g. a third detecting cycle). With narrower pairing extent R, the pairing of touch points can proceed with more accuracy.

The above-mentioned steps S51-S53 provide a feedback-and-adjustment mechanism for the pairing extent R. The tracking method can be adaptively adjusted in relation to the moving speed or moving distance of fingers, and the accuracy and correctness of touch point tracking can therefore be improved.

The tracking method of the present embodiment can further include a step of designating new touch points after step S30. One or more remaining unpaired candidate points are designated as one or more new touch points. In the present embodiment shown in FIG. 2d, two remaining unpaired candidate points Q4 and Q6 are not paired with any of the first touch points P1˜P5.

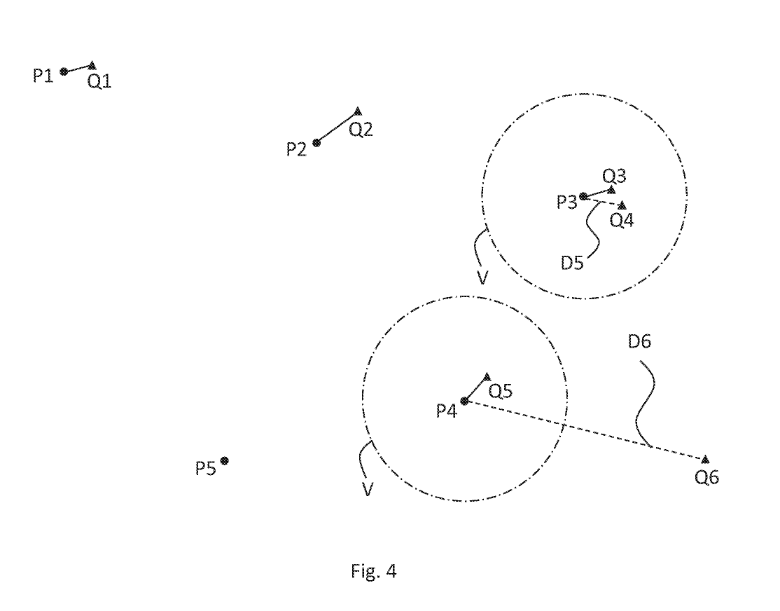

The step of designating new touch points will be elaborated in more detail with reference to FIG. 4. FIG. 4 is a schematic view of the location differences of the remaining unpaired candidate points and respective nearest first touch points. When a location difference between one remaining unpaired candidate point Q4 or Q6 and its nearest first touch point P3 or P4 is larger than a threshold V, the remaining unpaired candidate point Q4 or Q6 is set as one of the new touch points. When the location difference is larger than the threshold V, it means the remaining unpaired candidate point Q4 or Q6 is too far from the nearest first touch point P3 or P4 to be one the same trail with the first touch point P3 or P4. Therefore, it is decided that such remaining unpaired point Q4 or Q6 is the newly appeared touch point in the second detecting cycle.

As shown in FIG. 4, the first touch point P3 is the nearest to the remaining unpaired candidate point Q4, and they are separated by a first location difference D5. The first touch point P4 is the nearest to the remaining unpaired candidate point Q6, and they are separated by a second location difference D6. Assuming the threshold V lies between the first location difference D5 and the second location difference D6 in the present embodiment, the first location difference D5 is smaller than the threshold V and the second location difference D6 is larger than the threshold V. Therefore, only the remaining unpaired candidate point Q6 will be set as a new touch point; the candidate point Q4 will be discarded on the contrary.

To sum up, after the step of designating new touch point is finished, five touch points are detected in the second detecting cycle, including K (K equals four herein) second touch points (former candidate points Q1, Q2, Q3, and Q5) and one new touch point (former candidate point Q6). The tracking method then continues to a step of acquiring L first touch points. The L first touch points are acquired by aggregating the K second touch points and the new touch points. The tracking method is then resumed from the step of acquiring M candidate points based on the newly acquired L first touch points.

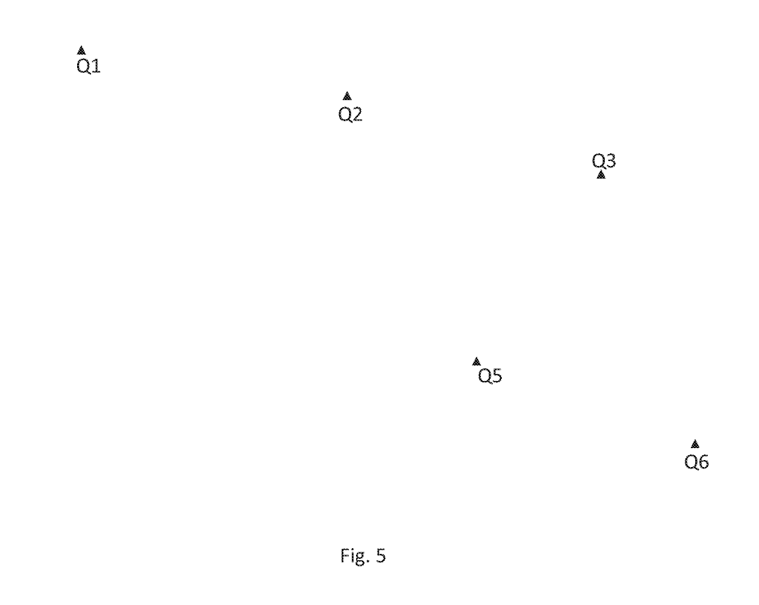

Please refer to FIG. 5 which is a schematic view of the new first touch points. In the present embodiment, the K second touch points (former candidate points Q1, Q2, Q3, and Q5) and the one new touch point (former candidate points Q6) are aggregated and regarded as the new L first touch points. The tracking method starts again from the step of acquiring M candidate points. Now in step S10, previous N first touch points are replaced with the new L first touch points, namely points Q1, Q2, Q3, Q5, and Q6, and the M candidate points are acquired subsequently. The following steps are performed accordingly, and they will not be elaborated again due to their similarities to the previously described steps.

According to the tracking method of the embodiment of the invention, by pairing the candidate points with the first touch points based on the pairing extent, and by assigning K paired candidate points as K second touch points, the touch points on the same touch trail can be defined. By way of such tracking method, the problems like error reporting and error tracking of the touch points can be avoided. Furthermore, by using a maximum interval distance to adjust the pairing extent, the accuracy and precision of tracking touch points can be increased.

A touch sensitive electronic device according to another embodiment of the invention will now be elaborated.

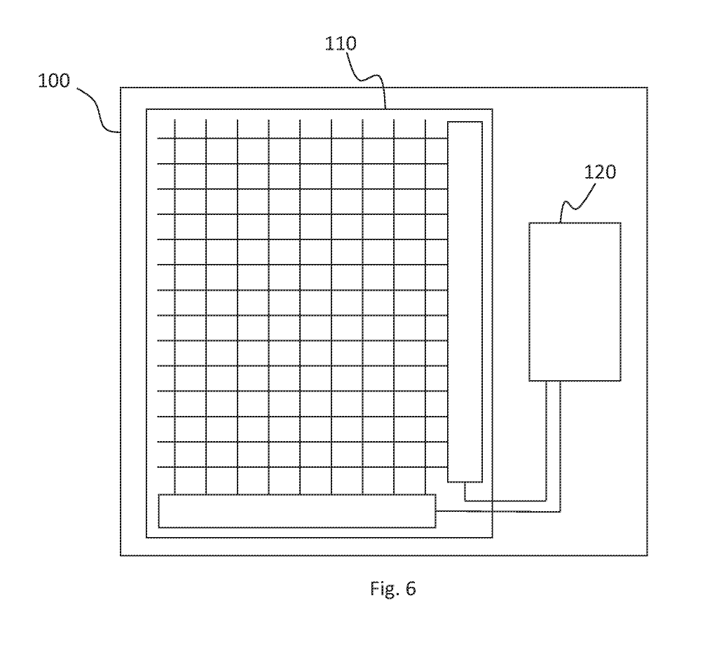

Please refer to FIG. 6 which is a schematic view of a touch sensitive electronic device according to another embodiment of the invention. The touch sensitive electronic device 100 includes a multitouch panel 110 and a touch control module 120. The multitouch panel 110 is used for generating multiple touch signals. The touch control module 120 is connected to the multitouch panel 110 for receiving the touch signals, so as to identify and track multiple touch points on the multitouch panel 110. The touch control module 120 can be electrically or communicationally connected to the multitouch panel 110.

More specifically, the touch control module 120 is configured to acquire N first touch points and M candidate points respectively in a first detecting cycle and a second detecting cycle after the first detecting cycle. When any one of the M candidate points situates within a pairing extent of any one of the N first touch points, the touch control module 120 is further configured to pair the candidate point and the first touch point. The pairing extent is a function of a minimum detecting value and a distance-between-finger value. The touch control module 120 is also configured to assign K paired candidate points as K second touch points. Each second touch point and corresponding first touch point are defined as being on the same trail. The touch control module 120 is further configured to retrieve a maximum interval distance from more than one pair of the candidate point and the first touch point, and then to adjust the pairing extent in accordance with the maximum interval distance.

In the present embodiment, the minimum detecting value and the distance-between-finger value can be set or acquired in advance and stored in the control module 120. The minimum detecting value and the distance-between-finger value can be determined in accordance with the detection resolution of hardware. Yet they can also be determined based on the factors like processing power of the touch control module 120 or the desirable response time. Still, these values can be determined based on user settings or actual operating conditions of the touch sensitive electronic device 100.

In another embodiment of the invention, the touch control module 120 is configured to perform a tracking method for touch points. The tracking method includes the following steps. First, N first touch points are acquired in a first detecting cycle, and then M candidate points are acquired in a second detecting cycle after the first detecting cycle. N and M are positive integers. When any one of the M candidate points situates within a pairing extent of any one of the N first touch points, the candidate point is paired with the first touch point. The pairing extent is a function of a minimum detecting value and a distance-between-finger value, and each pair of the candidate point and the first touch point has an interval distance therebetween. After K pairs of the candidate point and the first touch point are paired, assigning K paired candidate points as K second touch points, and each second touch point and corresponding first touch point are defined as being on the same trail. Further, a maximum interval distance is retrieved from the K pairs of the candidate point and the first touch point, and then the pairing extent is adjusted in accordance with the maximum interval distance.

Further details and contents of the tracking method performed by the touch control module 120 are similar to those of the tracking method according to the embodiment of the invention, and will not be repeated again.

The touch control module and the tracking method for touch points and the touch sensitive electronic device using the same have been elaborated in the above-mentioned embodiments of the invention. N first touch points are acquired in a first detecting cycle and M candidate points are acquired in a second detecting cycle after the first detecting cycle. The candidate point is paired with the first touch point according to the pairing extent. After K pairs of the candidate point and the first touch point are paired, the K paired candidate points are assigned as K second touch points. Each second touch point and corresponding first touch point are defined as being on the same touch trail. Afterward, a maximum interval distance from the K pairs of the candidate point and the first touch point are retrieved, and then the pairing extent is adjusted in accordance with the maximum interval distance. By using the pairing extent as the mechanism to determine whether the touch points are on the same trail or not, the faulty touch point tracking resulted from noises or increasing fingers can be prevented. The accuracy and correctness of tracking touch points can be improved. The feedback-and-adjust mechanism of the pairing extent can be utilized to realize a more adaptive, more flexible, and more accurate touch point tracking. The touch sensitive electronic device using the tracking method or using the touch control module can be operated in a more precise way, and therefore can provide better user experience and higher product quality.

The ordinal numbers used in the detailed description and claims, such as “first”, “second”, “third”, and “fourth”, do not necessarily indicate their priority orders; on the contrary, they are merely intended to distinguish different elements. Although the method steps in the detailed description are marked with orderly reference numbers, they are not intended to limit the priorities of the steps. Unless otherwise explicitly provided in the claim language, the order of the method steps may be performed in any possible manner. It will be apparent to those skilled in the art that various modifications and variations can be made to the structure of the present invention without departing from the scope or spirit of the invention. In view of the foregoing, it is intended that the present invention covers modifications and variations of this invention, provided they fall within the scope of the following claims.

What is claimed is:

1. A tracking method for touch points comprising:
acquiring N first touch points in a first detecting cycle;
acquiring M candidate points in a second detecting cycle after the first detecting cycle, wherein N and M are positive integers;
when any one of the M candidate points situates within a pairing extent of any one of the N first touch points, pairing the candidate point with the first touch point, wherein the pairing extent is a function of a minimum detecting value and a distance-between-finger value, and each pair of the candidate point and the first touch point has an interval distance therebetween;
after K pairs of the candidate point and the first touch point are paired, assigning K paired candidate points as K second touch points, wherein each second touch point and corresponding first touch point are defined as being on the same trail;
retrieving a maximum interval distance from the K pairs of the candidate point and the first touch point; and
adjusting the pairing extent in accordance with the maximum interval distance.

2. The tracking method of claim 1, wherein the pairing extent is in a circular shape whose radius is the sum of the distance-between-finger value and a half of the minimum detecting value.

3. The tracking method of claim 1, wherein the tracking method further comprises:
designating one or more remaining unpaired candidate points as one or more new touch points.

4. The tracking method of claim 3, wherein the designating step comprises:
when a location difference between one remaining unpaired candidate point and one nearest first touch point is larger than a threshold, setting the remaining unpaired candidate point as one of the new touch points.

5. The tracking method of claim 3, wherein the tracking method further comprises:
acquiring L first touch points by aggregating the K second touch points and the new touch points; and
resuming the tracking method from the step of acquiring M candidate points.

6. The tracking method of claim 1, wherein the step of adjusting the pairing extent comprises:
obtaining an evaluating value according to the minimum detecting value and the distance-between-finger value; and
updating the distance-between-finger value with double its original value when the maximum interval distance is greater than a half of the evaluating value, thereby expanding the pairing extent.

7. The tracking method of claim 6, wherein the evaluating value is a half of the sum of the minimum detecting value and the distance-between-finger value.

8. The tracking method of claim 1, wherein the step of adjusting the pairing extent comprises:
obtaining an evaluating value according to the minimum detecting value and the distance-between-finger value; and
updating the distance-between-finger value with half its original value when the maximum interval distance is smaller than a quarter of the evaluating value, thereby contracting the pairing extent.

9. The tracking method of claim 8, wherein the evaluating value is a half of the sum of the minimum detecting value and the distance-between-finger value.

10. A touch control module connected to a multitouch panel for receiving a plurality of touch signals from the multitouch panel, thereby identifying and tracking a plurality of touch points on the multitouch panel, and the touch control module configured to perform a tracking method comprising:
acquiring N first touch points in a first detecting cycle;
acquiring M candidate points in a second detecting cycle after the first detecting cycle, wherein N and M are positive integers;
when any one of the M candidate points situates within a pairing extent of any one of the N first touch points, pairing the candidate point with the first touch point, wherein the pairing extent is a function of a minimum detecting value and a distance-between-finger value, and each pair of the candidate point and the first touch point has an interval distance therebetween;
after K pairs of the candidate point and the first touch point are paired, assigning K paired candidate points as K second touch points, wherein each second touch point and corresponding first touch point are defined as being on the same trail;
retrieving a maximum interval distance from the K pairs of the candidate point and the first touch point; and
adjusting the pairing extent in accordance with the maximum interval distance.

11. A touch sensitive electronic device comprising:
a multitouch panel for generating a plurality of touch signals; and
a touch control module connected to the multitouch panel for receiving the touch signals, thereby identifying and tracking a plurality of touch points on the multitouch panel;
wherein the touch control model is configured to acquire N first touch point in a first detecting cycle and M candidate points in a second detecting cycle after the first detecting cycle, and when any one of the M candidate points situates within a pairing extent of any one of the N first touch points where the pairing extent is a function of a minimum detecting value and a distance-between-finger value, the touch control module is configured to pair the candidate point with the first touch point, and the touch control module is configured to assign K paired candidate points as K second touch points and each second touch point and corresponding first touch point are defined as being on the same trail, and the touch control module is further configured to retrieve a maximum interval distance from more than one pair of the candidate point and the first touch point, and to adjust the pairing extent in accordance with the maximum interval distance.
